(19) United States
(12) Patent Application Publication
(10) Pub. No.: US 2025/0233551 A1
(43) Pub. Date: Jul. 17, 2025

(54) SOLAR MODULE FASTENING DEVICE

(71) Applicant: Robert Zimmermann, Eberhardzell (DE)

(72) Inventor: Robert Zimmermann, Eberhardzell (DE)

(21) Appl. No.: 18/938,033

(22) Filed: Nov. 5, 2024

(30) Foreign Application Priority Data
Nov. 7, 2023 (DE) 10 2023 130 837.8

(51) Int. Cl. H02S 30/10

(52) U.S. Cl. CPC H02S 30/10

(57) ABSTRACT

A solar module fastening device with a mounting rail for a fastening of several solar modules, the mounting rail having at least one at least substantially continuous bearing surface which the solar modules can be slid onto for fastening, wherein the mounting rail comprises at least one mounting-securing element, which is configured to permit sliding of solar modules onto the bearing surface in a mounting direction and to secure the solar modules in mounting positions against a displacement counter to the mounting direction.

### CROSS-REFERENCE TO RELATED APPLICATION

This patent application is based on and claims priority to German Patent Application DE 10 2023 130 837.8, filed on Nov. 7, 2023, the contents of which are incorporated herein by reference.

### PRIOR ART

The invention concerns a solar module fastening device.

A solar module fastening device with a mounting rail for a fastening of several solar modules, the mounting rail having at least one at least substantially continuous bearing surface which the solar modules can be slid onto for fastening, has already been proposed.

The objective of the invention is in particular to provide a generic device having improved properties with regard to simple and quick mounting of solar modules and cost-effective production. The objective is achieved according to the invention.

### Advantages of the Invention

The invention is based on a solar module fastening device with a mounting rail for a fastening of several solar modules, the mounting rail having at least one at least substantially continuous bearing surface which the solar modules can be slid onto for fastening.

It is proposed that the mounting rail comprises at least one mounting-securing element, which is configured to permit sliding of solar modules onto the support surface in a mounting direction and to secure the solar modules in mounting positions against a displacement counter to the mounting direction.

A “solar module fastening device” is preferably to mean a device by means of which solar modules can be set up on a ground. The solar module fastening device forms a bearing structure by which the solar modules are fastened to the ground. The weight force of the solar modules and further forces acting on the solar modules, such as for example wind forces, are transferred into the ground via the solar module fastening device. The solar module fastening device preferably has a base frame. The base frame may preferably comprise a plurality of support elements which are fixedly connected to the ground. A “support element” is preferably to mean an element which is fixedly connected to the ground. The support element is preferably inserted in the ground. The support element is realized as an elongate prop configured to be inserted in the ground along its longitudinal axis. A support element is preferably realized as a ramming profile configured to be rammed into the ground for fastening to the ground. “Fastened to the ground” is preferably to mean connected to the ground in such a way that forces, preferably at least vertically acting forces, also laterally acting forces, can be discharged into the ground. Preferably, elements fastened to the ground, such as the support elements, are inserted in the ground, i.e. in particular rammed in or screwed in. In principle, it is preferably also conceivable that a support element is realized as a prop that is configured for a connection to a structure, such as for example a roof or another structure. The solar modules are preferably mounted rigidly and immovably by means of the solar module fastening device. The solar modules are fixedly mounted in a defined position by means of the solar module fastening device.

By a “solar module” is in particular a module to be understood which is configured to convert energy of sunlight. Preferably, a solar module is configured to generate an electric current from sunlight. Preferably, the solar module is realized as a photovoltaic module. A “mounting rail” is preferably to mean a rail on which at least one solar module, preferably several solar modules, are at least partly fixedly mountable. A mounting rail is configured for a fastening of at least one solar module, preferably of several solar modules, respectively on one side. A solar module is preferably fixedly mounted to the solar module fastening device via two mounting rails. A solar module is preferably in each case connected to a mounting rail via a lateral edge region. A mounting rail is configured such that at least one solar module, preferably several solar modules, at least partly rest on the mounting rail in a side region and are connectable to the mounting rail via at least one respective fastening module in a force-fitting and/or form-fitting manner. A “bearing surface” is preferably to mean a surface on which a solar module rests, preferably in planar fashion, with a support region on the mounting rail. The bearing surface is preferably realized as a planar surface. In a mounted or pre-mounted state, a solar module rests on the bearing surface of the mounting rail with a rear side of a lateral frame region. The bearing surface is realized as a support surface. The bearing surface is configured to support forces, for example weight forces, of the solar modules. The solar modules are preferably pressed onto the bearing surface for a connection to the mounting rail. For a fastening to the mounting rail, the solar modules are preferably clamped between the bearing surface and a counterpart, for example a clamping surface of a clamping element, and are thus mounted in a force-fitting manner. “Can be slid on” is preferably to mean that the solar modules, in particular with an edge region, rest on the bearing surfaces and are slidable on the bearing surfaces in a gliding manner.

A “mounting-securing element” is preferably to mean a securing element configured to hold a solar module in a defined position in a force-fitting and/or form-fitting manner. The mounting-securing element is configured for a form-fitting safeguarding against a displacement counter to the mounting direction. Preferably the mounting-securing element has an inclined ramp surface over which an element, such as in particular a solar module, can be traversed in a mounting direction. Preferably the mounting-securing element has a securing surface which a solar module abuts on in a form-fitting manner in the event of a movement counter to the mounting direction. The securing surface is configured to prevent, by a form-fitting contact, a solar module being traversed counter to the mounting direction. “Configured” is in particular to mean specifically designed and/or equipped. By an object being configured for a specific function is in particular to be understood that the object fulfils and/or carries out this specific function in at least one application state and/or operation state. A “mounting direction” is preferably to mean a direction in which the solar modules can be slid onto the mounting rails. The mounting direction preferably runs from a front lower end of the mounting rails to a rear upper end of the mounting rails. A “mounting position” is preferably to mean a position of a solar module on the mounting rail in which the solar module is aligned correctly for fastening to the mounting rail. In the mounting position the solar module can be mounted on the mounting rails in a loss-proof manner by means of fastening modules. An implementation according to the invention allows providing a mounting rail in an advantageously simple manner, wherein solar modules can be held on the mounting rail in a pre-mounted state in a particularly simple manner before they are fixedly mounted by means of a fastening module. This enables particularly quick and easy mounting of the solar modules on the solar module fastening device. As a result, it is in particular advantageously possible to reduce costs for the installation of a system of solar modules and a solar module fastening device.

It is further proposed that the at least one mounting-securing element is arranged on the bearing surface and rises from the bearing surface. As a result, the mounting-securing element can be realized in a particularly advantageous manner for securing the mounting of a solar module.

Furthermore, it is proposed that the at least one mounting-securing element is realized as a tab bent out from the bearing surface. A “bent-out tab” is preferably to mean an element which is realized integrally with the bearing surface, is partly separated from a remaining portion of the bearing surface and is bent in a direction away from the bearing surface. This allows realizing the mounting-securing element in a particularly simple manner.

It is also proposed that the mounting rail has a vertical wall which, at least in a subregion, forms a lateral support surface for the solar modules. A “vertical wall” is preferably to mean a wall extending in a vertical direction upwards, away from the bearing surface, and forms a lateral abutment surface. This allows realizing the mounting rail in a particularly advantageous manner for simple sliding-on of the solar modules. Due to the lateral support of the solar modules by the vertical wall, it is especially advantageously possible for a solar module to be guided while being slid onto the mounting rail.

It is moreover proposed that the vertical wall of the mounting rail is realized so as to be inclined and forms the lateral support surface only in an upper region that faces away from the bearing surface. “Realized so as to be inclined” is preferably to mean that the vertical wall includes an angle with the bearing surface that is unequal to 90 degrees. The vertical wall is preferably inclined towards the adjacent bearing surface. The vertical wall includes an angle with the adjacent bearing surface that is less than 90 degrees. The vertical wall includes an angle with the adjacent bearing surface that is between 89 degrees and 75 degrees, preferably between 85 degrees and 80 degrees. This allows realizing a lateral abutment surface for a solar module that is advantageously small, as a result of which it is advantageously possible to keep a frictional resistance low during mounting, in particular when a solar module is slid onto the mounting rail, wherein lateral guidance is always ensured.

It is further proposed that the mounting rail has a second at least substantially continuous bearing surface, onto which further solar modules can be slid for fastening. By a “second bearing surface” is preferably a bearing surface to be understood, which is realized substantially identically, which is preferably realized spaced apart from the first bearing surface and which is configured to support solar modules of a further row of solar modules. The second bearing surface extends parallel to the first bearing surface. The second bearing surface is preferably realized in a plane with the first bearing surface. The second bearing surface is preferably realized on a side of the mounting rail that is situated opposite the first bearing surface. This allows realizing the mounting rail advantageously for a fastening of two rows of solar modules.

Beyond this, it is proposed that the mounting rail has a mounting surface which is elevated relative to the bearing surfaces, which extends between the bearing surfaces and which is configured for connecting fastening modules for a fastening of the solar modules. A “mounting surface” is preferably to mean a surface on which a fastening module can be mounted in a loss-proof manner. This allows realizing the mounting rail particularly advantageously for the connection of fastening modules.

It is also proposed that, for the fastening of a fastening module, the mounting rail has several mounting holes in a mounting surface which is elevated relative to the bearing surfaces. A “fastening module” is preferably to mean a module configured for a fixed mounting of a solar module. In a mounted state, the fastening module is configured for a form-fitting and/or force-fitting connection of a solar module with the mounting rail. A mounting module is preferably configured to fasten a solar module to the mounting rail via clamping. In principle, it would also be conceivable that a fastening module is configured for a form-fitting connection with a solar module. The fastening module is configured to be fastened to the mounting rail in a force-fitting and/or form-fitting manner. This allows realizing the mounting rail in a particularly simple manner for the connection of the solar modules.

It is furthermore proposed that two mounting holes are realized as pre-mounting and positioning holes, having respectively different diameters. A “pre-mounting and positioning hole” is preferably to mean a hole, preferably a through hole or blind hole having a round cross-section, which is configured such that a corresponding element, in particular a positioning pin, can be inserted therein for a mounting, in particular a pre-mounting. Due to the different diameters of the pre-mounting and positioning holes, nothing but a correct mounting of a fastening module to be fastened is possible. This advantageously facilitates fault-free mounting.

It is also proposed that the mounting rail has, in the mounting surface, a mounting hole which is realized as a fastening hole, which is preferably arranged between the two mounting holes realized as pre-mounting and positioning holes and which is configured such that a fastening means, in particular a screw element, protrudes through it for the connection of a fastening module. This allows connecting the fastening module to the mounting surface in a particularly simple manner.

It is moreover proposed that the mounting rail has, in the mounting surface, the mounting hole realized as a fastening hole, which extends as far as and into the vertical wall that is arranged between the mounting surface and the first bearing surface. The subregion of the mounting hole realized as a fastening hole has a width that is greater than a width in the region of the mounting surface. The subregion of the mounting hole realized as a fastening hole, which extends into the vertical wall, is in particular realized having a greater width than a screw head of a screw element of the fastening module. The subregion of the mounting hole realized as a fastening hole, which extends into the vertical wall, is configured such that a screw element can be guided through said subregion with its screw head for the connection of the screw element and thus of the fastening module. This preferably allows ensuring a simple mounting of the fastening module.

Beyond this it is proposed that the solar module fastening device comprises a fastening module configured to fasten at least one solar module to the mounting rail in a clamping manner, the fastening module being configured to be fastened to a mounting hole that is realized as a fastening hole. By a “fastening module” is preferably a module to be understood which is, in a mounted state, configured for a force-fitting and/or form-fitting connection of a solar module with the mounting rail. In this way, a solar module can be fastened to the mounting rail in a particularly simple manner.

It is further proposed that the fastening module is configured to be pre-mounted at the mounting holes in a self-securing manner. By “pre-mounted in a self-securing manner” is preferably to be understood that the fastening module can be pre-mounted such that it is arranged on its own on the mounting rail. The fastening module is configured to exert a pre-tensioning force onto a screw element of the fastening module by its spring element. For a self-securing pre-mounting, the fastening module is configured to be clamped with its screw element at a mounting hole that is realized as a fastening hole. In this way, a mounting of the solar modules can be realized with the simply pre-mounted fastening modules in a particularly simple manner. A mounting of solar modules on the mounting rails can be realized in a particularly simple and quick manner.

It moreover proposed that the fastening module comprises a clamping element and a spring element, the spring element being arranged between the mounting surface and the clamping element. By a “clamping element” is preferably an element to be understood which is configured to clamp a solar module between itself and a bearing surface. The clamping element is connected to the mounting rail via a screw element and a nut of the fastening module. By tightening the screw element at the nut that is connected to the clamping element, the clamping element is moved towards the bearing surfaces. The spring element is preferably realized as a compression spring. The spring element is configured to be compressed counter to a spring force. The spring element is preferably made of a plastic. The spring element preferably comprises a first connection region, with which the spring element adjoins the clamping element. The spring element preferably comprises a second connection region, with which the spring element adjoins the mounting surface of the mounting rail. The spring element is configured to provide a holding force by which the fastening module can be held at the mounting hole of the mounting rail in a loss-proof manner for pre-mounting. This allows realizing the fastening module in a particularly simple manner.

Furthermore, it is proposed that the fastening module can be pre-mounted in a positionally secure manner via mounting holes which are realized as pre-mounting and positioning holes, wherein the spring element preferably comprises positioning pins which are inserted into the mounting holes, realized as pre-mounting and positioning holes, for a pre-mounting. This allows correct fastening of the spring element—and thus of the entire fastening module—to the mounting rail in a particularly simple manner.

The solar module fastening device according to the invention shall here not be limited to the above-described application and implementation. In particular, in order to fulfil a functionality that is described here, the solar module fastening device according to the invention may have a number of individual elements, components and units that differs from a number given here.

### DRAWINGS

Further advantages will become apparent from the following description of the drawings. An exemplary embodiment of the invention is shown in the drawings. The drawings, the description and the claims contain a plurality of features in combination. Someone skilled in the art will purposefully also consider the features individually and will find further expedient combinations.

In the drawings:

FIG. 1 shows a schematic view of a system of a portion of a solar module fastening device with several solar modules, which are mounted on the solar module fastening device in rows via mounting rails,

FIG. 2 shows a schematic sectional view through a mounting rail of the two bearing surfaces, on which respectively one solar module rests,

FIG. 3 shows a schematic sectional view through a mounting rail with a fastening module in a pre-mounted state,

FIG. 4 shows a schematic sectional view through a mounting rail with a fastening module in a mounted state, in which the fastening module fastens the two solar modules to the mounting rail,

FIG. 5 shows a schematic detailed view of a section of a mounting rail with two mounting-securing elements which secure two solar modules in a pre-mounted position,

FIG. 6 shows a schematic sectional view of a mounting rail with two mounting-securing elements arranged on the bearing surfaces,

FIG. 7 shows a schematic view of a mounting rail with a detailed view of a fastening region of the mounting rail for the connection of a fastening module,

FIG. 8 shows a schematic side view of sections of the mounting rail,

FIG. 9 shows a schematic plan view of sections of the mounting rail,

FIG. 10 shows a schematic view from below of sections of the mounting rail,

FIG. 11 shows a schematic view of a portion of the mounting rail with a pre-mounted fastening module,

FIG. 12 shows a schematic view of a portion of a solar module fastening device during mounting of a solar module which is slid onto two mounting rails, and

FIG. 13 shows a schematic view of a portion of a fastening module with the clamping element and the spring element.

### DESCRIPTION OF THE EXEMPLARY EMBODIMENT

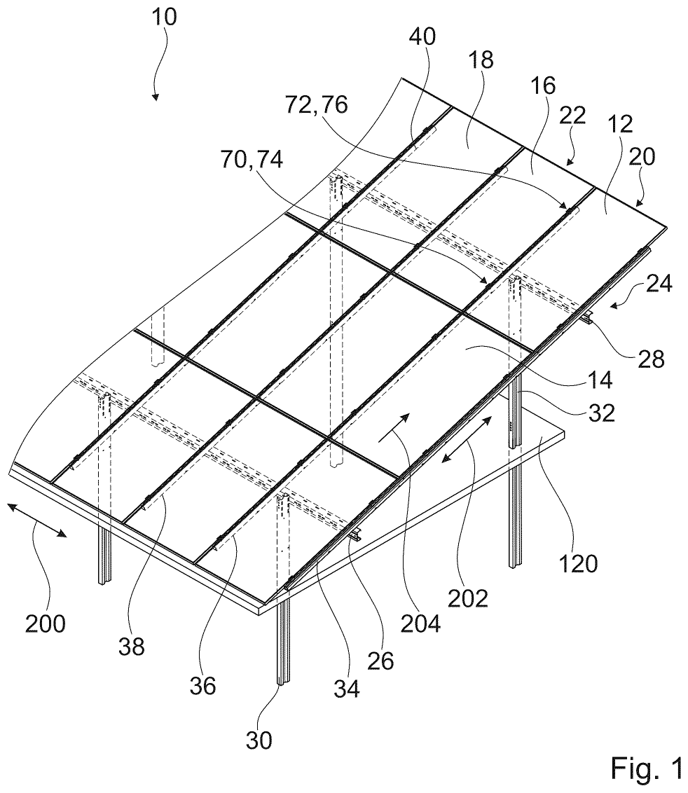

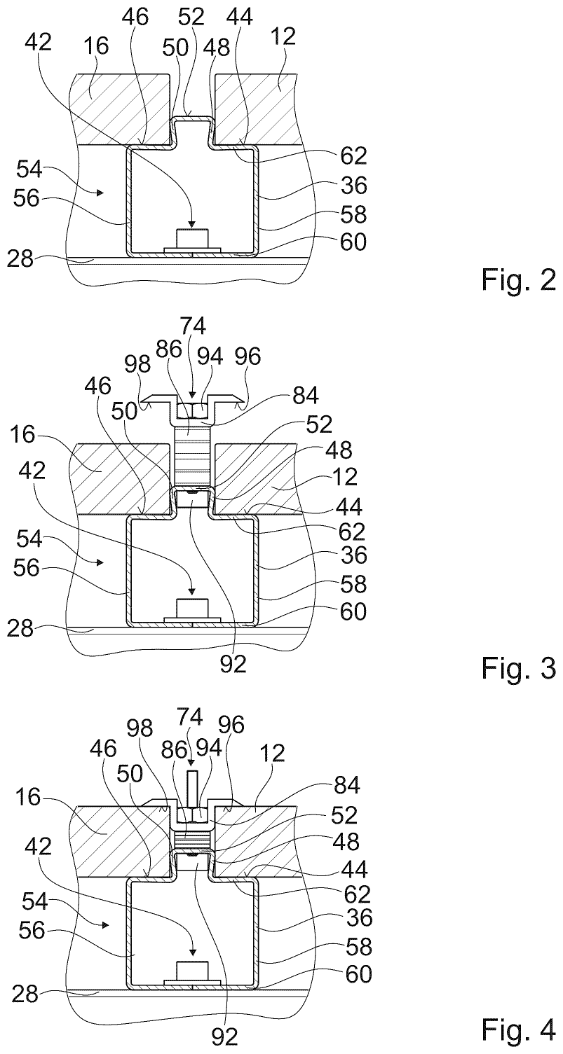

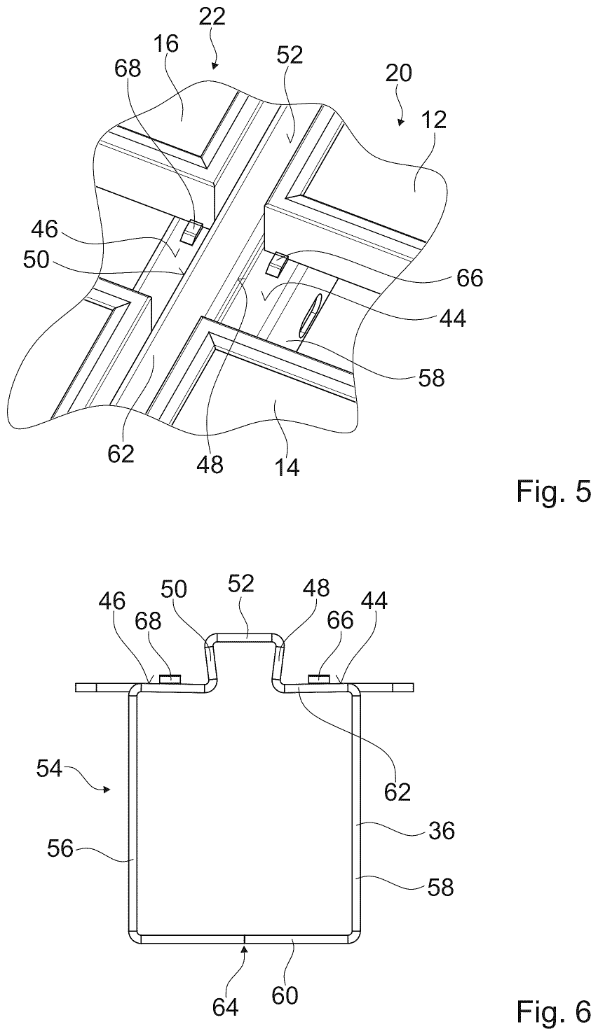

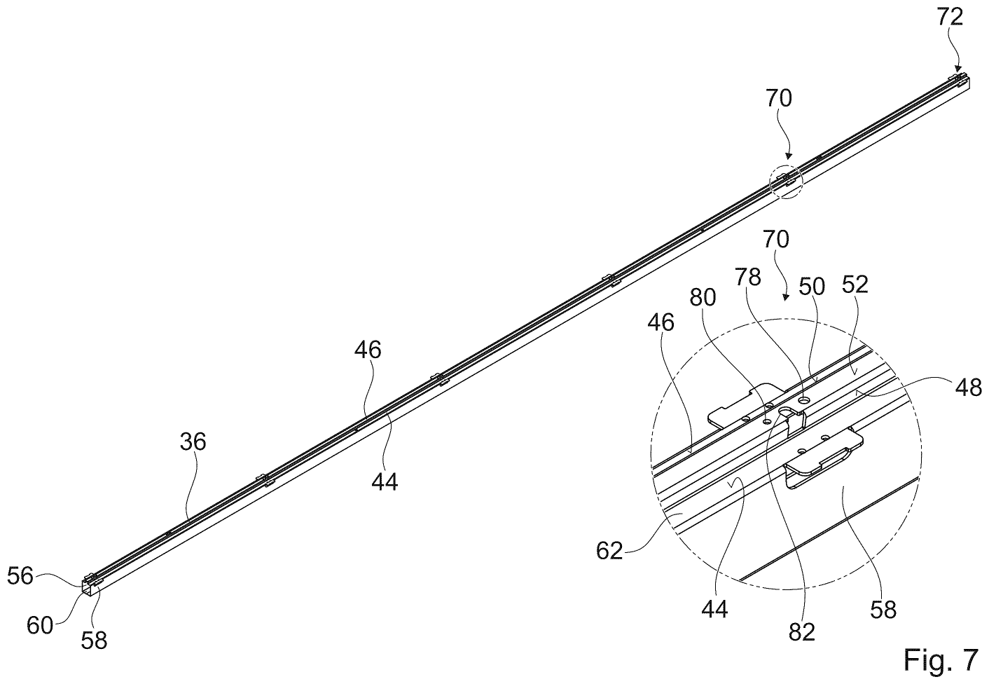

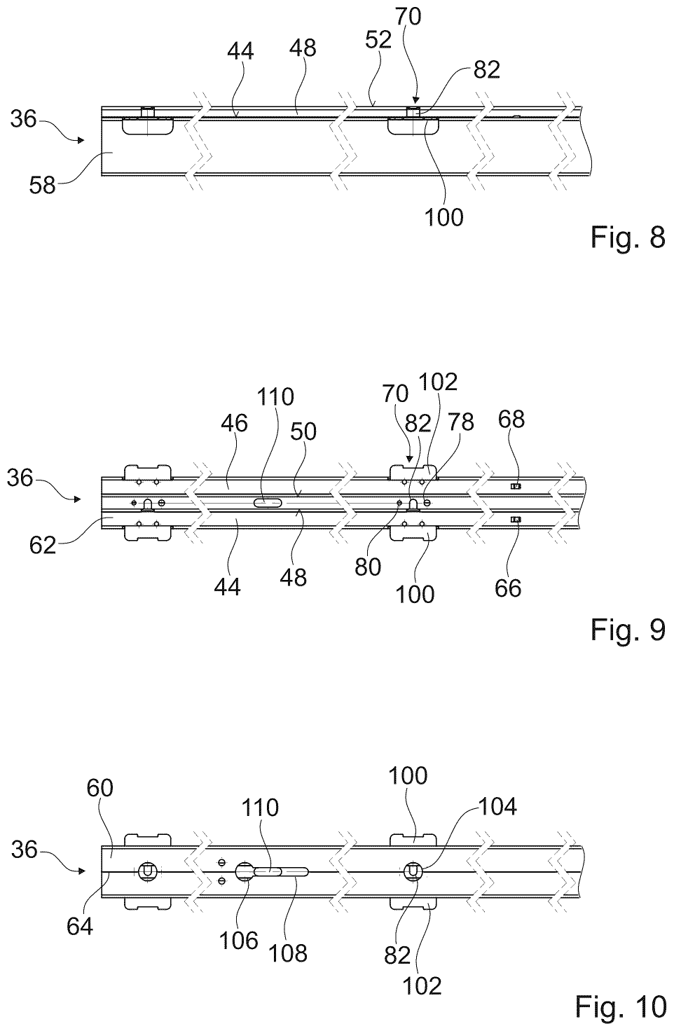

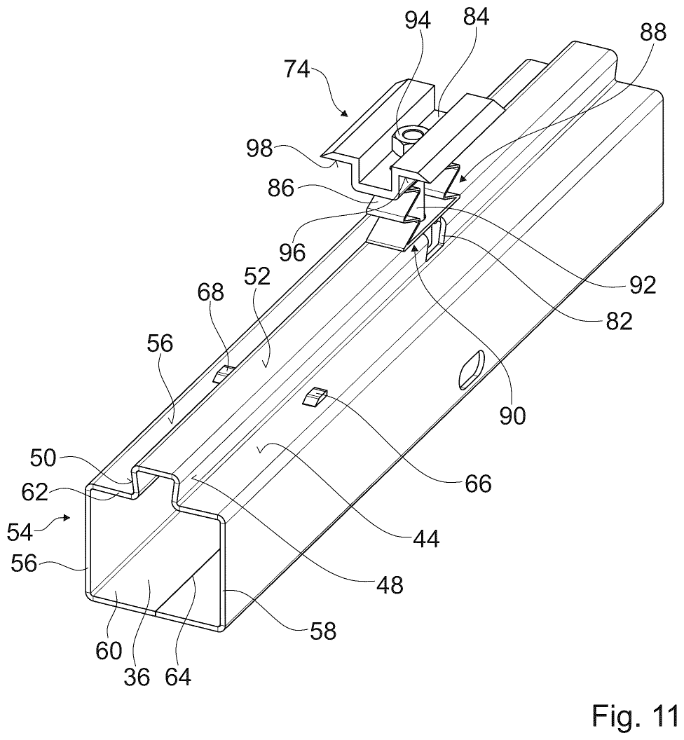

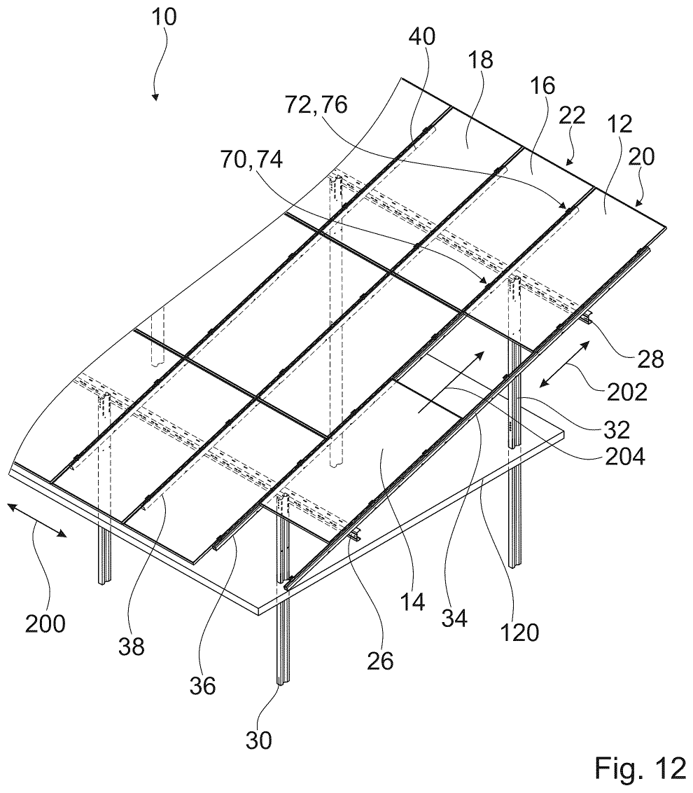

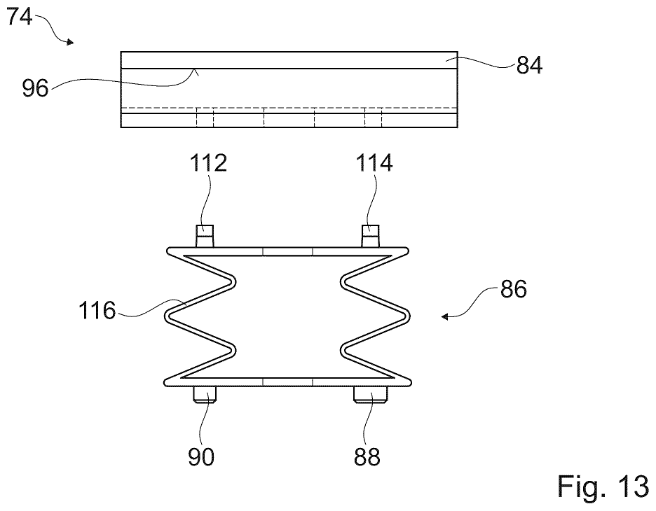

FIGS. 1 to 12 show a solar module fastening device 10 according to the invention. The solar module fastening device 10 is configured for the connection of solar modules 12, 14, 16, 18. The solar module fastening device 10 is configured for a rigid connection of several solar modules 12, 14, 16, 18. The solar module fastening device 10 is preferably realized for an orientation-fix mounting of a plurality of solar modules 12, 14, 16, 18. The solar modules 12, 14, 16, 18 are preferably mounted on a ground 120 in a fixed orientation by means of the solar module fastening device. A plurality of solar modules 12, 14, 16, 18 are mounted side by side in a plurality of rows 20, 22 by means of the solar module mounting device 10. By way of example, three solar modules 12, 14, 16, 18 are arranged in each row 20, 22. In principle, it would also be conceivable that a different number of solar modules 12, 14, 16, 18 are arranged in one row. At least two solar modules 12, 14, 16, 18 are arranged in one row 20, 22. Preferably, it is also conceivable that four or more than four solar modules 12, 14, 16, 18 are arranged in one row 20, 22. The solar module fastening device 10 comprises at least one row 20, 22 of solar modules. The solar module fastening device 10 preferably comprises a plurality of rows 20, 22 of solar modules 12, 14, 16, 18. Depending on its extent in a longitudinal axis 200 of the solar module fastening device 10, the solar module fastening device 10 may comprise between two and ten or more rows 20, 22 of solar modules 12, 14, 16, 18.

The solar module fastening device 10 has a base frame 24. The base frame 24 preferably comprises at least two transversal beams 26, 28. The transversal beams 26, 28 preferably extend parallel to one another. The transversal beams are preferably realized as steel beams. The first transversal beam 26 is realized as a front transversal beam. The front transversal beam 26 is realized as a lower transversal beam. The second transversal beam 28 is realized as a rear transversal beam. The rear transversal beam 28 is realized as an upper transversal beam. The rear transversal beam 28 is arranged at a greater height than the front transversal beam. Due to the arrangement of the transversal beams 26, 28 at different heights, the solar modules 12, 14, 16, 18 are mounted in inclined fashion by means of the solar module fastening device 10. The base frame 24 comprises a plurality of support elements 30, 32 per each transversal beam 26, 28. The support elements 30, 32 are realized as ramming profiles configured to be rammed into the ground 120 for fastening. The base frame 24 comprises at least two support elements 30, 32 per each transversal beam 26, 28. Depending on the length of the transversal beams 26, 28, the base frame comprises more than two support elements 30, 32 for fastening to the ground 120. In principle, it would also be conceivable that the support elements 30, 32 are realized in a different way and/or are connected to the ground 120. For example, a screw connection or an embedding in concrete would also be conceivable.

The solar module fastening device 10 comprises a first mounting rail 34 for a fastening of several solar modules 12, 14, 16, 18. The solar module fastening device 10 comprises a second mounting rail 36 for a fastening of several solar modules 12, 14, 16, 18. For each row 20, 22 of solar modules 12, 14, 16, 18, the solar module fastening device 10 comprises two mounting rails 34, 36 respectively. The solar module fastening device 10 comprises further mounting rails 38, 40, of which only two further mounting rails 38, 40 are shown in the figures. Depending on its extent in the longitudinal axis 200 of the solar module fastening device 10, the solar module fastening device 10 comprises more or fewer mounting rails 34, 36, 38, 40 and thus rows 20, 22 of solar modules 12, 14, 16, 18. Preferably, the solar module fastening device 10 comprises (n+1) mounting rails 34, 36, 38, 40, n denoting the number of rows 20, 22 of solar modules 12, 14, 16, 18. Preferably, the solar module fastening device 10 comprises exactly one mounting rail 34, 36, 38, 40 more than rows 20, 22 of solar modules 12, 14, 16, 18. The mounting rails 34, 36, 38, 40 are in each case aligned at least substantially in a transversal axis 202 of the solar module fastening device 10. Preferably, the mounting rails 34, 36, 38, 40 are aligned orthogonally to the transversal beams 26, 28. The mounting rails 34, 36, 38, 40 preferably rest on an upper side of the transversal beams 26, 28. The mounting rails 34, 36, 38, 40 are preferably mounted rigidly on an upper side of the transversal beams 26, 28. Preferably, the mounting rails 34, 36, 38, 40 are fixedly connected to the transversal beams 26, 28 via a force-fitting and/or form-fitting connection. Preferably, the mounting rails 34, 36, 38, 40 are in each case connected to the transversal beams 26, 28 by means of at least one screw connection 42.

The mounting rails 34, 36, 38, 40 are preferably in each case configured for the partial connection of solar modules 12, 14, 16, 18 of two neighboring rows 20, 22. The mounting rails 34, 36, 38, 40 are in each case configured to fixedly connect solar modules 12, 14, 16, 18 of two neighboring rows 20, 22 in their side regions. The mounting rail 34 is realized as a first side mounting rail 34. The first mounting rail 34 is configured for the partial connection of solar modules 12, 14 of the first row 20. The first mounting rail 34 is configured for the connection of the solar modules 12, 14 in their first side region. The mounting rail 36 is realized as a second mounting rail. The mounting rail 36 is configured, together with the first mounting rail 34, for the connection of the solar modules 12, 14 of the first row 20. The mounting rail 36 is configured for the partial connection of the solar modules 12, 14 of the first row 20 and of the solar modules 16 of the second row 22.

The mounting rails 34, 36, 38, 40 are preferably realized substantially identically. The mounting rails 34, 36, 38, 40 of the solar module fastening device 10 are preferably realized identically. Therefore, in the following only the one mounting rail 36 will be described in detail. All other mounting rails 34, 38, 40 are realized identically. Therefore, the following description of the one mounting rail 36 may be referred to for explaining the further mounting rails 34, 38, 40.

The mounting rail 36 has a first at least substantially continuous bearing surface 44. The bearing surface 44 is configured such that solar modules 12, 14 can be mounted thereon. The bearing surface 44 is realized as a support surface. The bearing surface 44 is configured such that solar modules 12, 14 rest thereon in a mounted state. The bearing surface 44 is configured such that solar modules 12, 14 can be slid on for fastening. The bearing surface 44 is configured such that solar modules 12, 14 of a row 20 can rest thereon with their lateral edges. The bearing surface 44 is realized in planar fashion. The bearing surface 44 extends from a front end as far as a rear end of the mounting rail 36. The bearing surface 44 preferably extends over an entire length of the mounting rail 36. The bearing surface 44 is preferably realized in continuous fashion. In principle, however, a divided bearing surface 44 would also be conceivable, realized by subsegments which are separated from one another by interruptions. The first bearing surface 44 is realized as a first edge region of the mounting rail. The first bearing surface is arranged in the first, right-hand edge region of the mounting rail 36.

The mounting rail 36 has a second at least substantially continuous bearing surface 46. The second bearing surface 46 is configured for a mounting of further solar modules. The bearing surface 46 is configured such that solar modules 16 can be mounted thereon. The bearing surface 46 is realized as a support surface. The bearing surface 46 is configured such that solar modules 16 rest thereon in a mounted state. The bearing surface 46 is configured such that solar modules 16 can be slid thereon for fastening. The bearing surface 46 is configured such that solar modules 16 of a row 22 can rest thereon with their lateral edges. The bearing surface 46 is realized in planar fashion. The bearing surface 46 extends from a front end as far as a rear end of the mounting rail 36. The bearing surface 46 preferably extends over an entire length of the mounting rail 36. The bearing surface 46 is preferably realized in continuous fashion. In principle, however, a divided bearing surface 46 would also be conceivable, realized by subsegments which are separated from one another by interruptions. The second bearing surface 46 extends parallel to the first bearing surface 44. The second bearing surface 46 is arranged spaced apart from the first bearing surface 44. The two bearing surfaces 44, 46 are preferably realized substantially identically. The second bearing surface 46 is arranged spaced apart from the first bearing surface 44 in the transversal direction of the mounting rail 36. The second bearing surface 46 is realized as a second edge region of the mounting rail 36. The second bearing surface 46 is arranged in the second, left-hand edge region of the mounting rail 36. The second bearing surface 46 is realized as the second edge region of the mounting rail 36, which is situated opposite the first edge region that realizes the first bearing surface 44.

The mounting rail 36 has a first vertical wall 48. The first vertical wall 48 forms, at least in a subregion, a lateral support surface for the solar modules 12, 14. The first vertical wall 48 is assigned to the first support surface 44. The first vertical wall 48 is arranged on an inner side of the first bearing surface 44. The first vertical wall 48 is arranged on a side of the first support surface 44 that faces towards the second support surface 46. The support surface 44 merges on its inner side into the vertical wall 48. The vertical wall 48 is configured such that solar modules 12, 14 of the row 20 can be supported laterally thereon. The vertical wall 48 is configured for a longitudinal guidance of the solar modules 12, 14 of the row 20. The vertical wall 48 is realized for a lateral positioning of the solar modules 12, 14. The vertical wall 48 is realized so as to be inclined. The vertical wall 48 is inclined towards the first support surface 44. The vertical wall 48 preferably includes an angle of 84 degrees with the support surface 44. An angle included by the vertical wall 48 with the first support surface 44 is preferably between 75 and 89 degrees, particularly preferably between 80 and 85 degrees. Due to the inclined orientation of the vertical wall 48, a contact surface of the wall 48 against which the solar modules can abut can be kept very small, such that it is advantageously possible to keep a friction between the solar module 12, 14 and the vertical wall 48 small during mounting, in particular when sliding-on of the respective solar module 12, 14. This allows keeping a displacement force for displacing a solar module 12, 14 on the mounting rail 36 advantageously small.

The mounting rail 36 has a second vertical wall 50. The second vertical wall 50 forms, at least in a subregion, a lateral support surface for the solar modules 16. The second vertical wall 50 is assigned to the second support surface 46. The second vertical wall 50 is arranged on an inner side of the second support surface 46. The second vertical wall 50 is arranged on a side of the second support surface 46 that faces towards the first support surface 44. The second support surface 46 merges on its inner side into the second vertical wall 50. The second vertical wall 50 is configured such that solar modules 16 of the row 22 can be supported thereon laterally. The second vertical wall 50 is configured for a longitudinal guidance of the solar modules 16 of the row 22. The second vertical wall 50 is formed for a lateral positioning of the solar modules 16. The second vertical wall 50 is likewise realized so as to be inclined. The second vertical wall 50 is inclined towards the second support surface 46. The second vertical wall 50 preferably includes an angle of 84 degrees with the support surface 46. An angle included by the second vertical wall 50 with the second support surface 46 is preferably between 75 degrees and 89 degrees, particularly preferably between 80 degrees and 85 degrees. Due to the inclined orientation of the vertical wall 50, it is possible to keep a contact surface of the wall 50, against which the solar modules 16 can abut, very small, such that it is advantageously possible to keep a friction between the solar module 16 and the vertical wall 50 small during mounting, in particular during sliding-on of the respective solar module 16. This allows keeping a displacement force for displacing a solar module 16 on the mounting rail 36 advantageously small.

The mounting rail 36 has a mounting surface 52, which is elevated relative to the bearing surfaces 44, 46. The elevated mounting surface 52 is arranged between the two bearing surfaces 44, 46. The elevated mounting surface 52 is arranged in each case on an inner side of the bearing surfaces 44, 46. The elevated mounting surface 52 is arranged between the two vertical walls 48, 50. The elevated mounting surface 52 is arranged in each case on an inner side of the vertical walls 48, 50. The elevated mounting surface 52 is arranged in each case at an upper end of the vertical walls 48, 50. The mounting surface 52 in each case merges into the vertical walls 48, 50. The elevated bearing surface 52 is configured for the fastening of fastening modules 74, 76 for the purpose of connecting the solar modules 12, 14, 16.

The mounting rail 36 is realized as a profile tube. The mounting rail 36 is realized as a metal tube. For example, the mounting rail 36 can be realized as a steel tube. The mounting rail 36 has a partly rectangular cross-section. The mounting rail 36 has a substantially rectangular main body 54. The mounting rail 36 has two side walls 56, 58, a bottom wall 60 and an upper wall 62. The side walls 56, 58, the bottom wall 60 and the upper wall 62 form the base body 54. The side walls 56, 58, the bottom wall 60 and the upper wall 62 are realized integrally with one another. The mounting rail 36 is realized as a suitably bent sheet, in particular a metal sheet. The bottom wall 60 preferably comprises a weld seam 64 at which the ends of the bent sheet are welded with one another for producing the closed profile tube. In principle, it would also be conceivable that the mounting rail 36 is realized as a rod-extruded profile. For a connection to the transversal beams 26, 28, the mounting rail 36 has respectively at least one fastening hole 108 in its bottom wall 60. Preferably, the mounting rail 36 has at least two fastening holes 108. In principle, it is also conceivable that the fastening rail 36 has more than two fastening holes 108, such that the mounting rail 36 is variably connectable to a plurality of transversal beams 26, 28, with differently spaced apart transversal beams 26, 28. The fastening holes 108 are realized identically, which is why in the following only one fastening hole 108 will be described in detail. The fastening hole 108 is configured such that a screw element of the screw connection 42 can be guided through for the connection to a transversal beam 26, 28. The fastening hole 108 is realized as a long hole. This allows the mounting rail 36 being displaced to the corresponding transversal beam 26, 28 and being correctly positioned before the mounting rail 36 is tightened by means of the screw connection 42. The fastening hole 108 forms a mounting hole 106 at one end. The mounting hole 106 has a greater diameter than the fastening hole 108 that is realized as a long hole. The mounting hole 106 has a diameter that is greater than a head diameter of a fastening screw of the screw connection 42. The fastening screw of the screw connection 42 can be inserted easily through the mounting hole 106 and into the fastening hole 108 for the mounting of the mounting rail 36 on the transversal beam 26, 28. On the opposite side of the fastening hole 108, the mounting rail 36 has, in particular in its mounting surface 52, a mounting hole 110 that is configured such that a tool for tightening the fastening screw of the screw connection 42 can be guided through said mounting hole 110.

The bearing surfaces 44, 46, the vertical walls 48, 50 and the mounting surface 52 are realized by the upper wall 62 of the mounting rail 36. The bearing surfaces 44, 46, the vertical walls 48, 50 and the mounting surface 52 form the upper wall 62. The bearing surfaces 44, 46, the vertical walls 48, 50 and the mounting surface 52 are realized integrally with the upper wall 62.

The mounting rail 36 comprises at least one mounting-securing element 66, which is configured to permit sliding of solar modules 12, 14 onto the bearing surface 44 in a mounting direction 204 and to secure the solar modules 12, 14 in mounting positions against a displacement counter to the mounting direction 204. The mounting rail 36 comprises at least one further mounting-securing element 68, which is configured to permit sliding of solar modules 16 onto the bearing surface 46 in a mounting direction 204 and to secure the solar modules 16 in mounting positions against a displacement counter to the mounting direction 204. The mounting rail 36 preferably comprises respectively one mounting-securing element 66, 68 for each row 20, 22, preferably for each solar module 12, 14, 16 of the row 20, 22. For each bearing surface 44, 46, the mounting rail 36 comprises a mounting-securing element 66, 68 for each solar module 12, 14, 16 that is to be fastened. In the exemplary embodiment shown, in which the rows 20, 22 are respectively composed of three solar modules 12, 14, 16, 18, the mounting rail 36 comprises six mounting-securing elements 66, 68, wherein respectively three mounting-securing elements 66, 68 are assigned to one bearing surface 44, 46. The mounting-securing elements 66, 68 are in each case assigned to one bearing surface 44, 46. The mounting-securing elements 66, 68 are preferably realized identically. Therefore, in the following only the one mounting-securing element 66 will be described in detail. The other mounting-securing elements 68 of the mounting rail 36 are realized identically, and an explanation may be done on the basis of the following description of the one mounting-securing element 66.

The mounting-securing element 66 is arranged on the bearing surface 44. The mounting-securing element 66 rises from the bearing surface 44. The mounting-securing element 66 extends upwards away from the bearing surface 44. The mounting-securing element 66 extends away from the bearing surface 44 in the mounting direction 204. The mounting-securing element 66 has a ramp surface which extends away from the bearing surface 44. The ramp surface has a distance from the bearing surface 44 which increases in the mounting direction 204. The ramp surface of the mounting-securing element 66 is configured such that during a mounting, when the mounting-securing element 66 is displaced on the bearing surface 44, a solar module 12, 14 can be traversed across the ramp surface of the mounting-securing element 66 in the mounting direction 204. The mounting-securing element 66 has a securing surface. The securing surface is aligned substantially orthogonally to the bearing surface 44. The securing surface of the mounting-securing element 66 is configured such that in a mounting position of a solar module 12, 14, the solar module 12, 14 is connected thereto with its lower edge in a form-fitting manner. The securing surface 66 is oriented towards a rear, upper end of the mounting rail. The mounting-securing element 66 is realized as a bent-out tab. The mounting-securing element 66 is realized integrally with the bearing surface 44. In order to form the mounting-securing element 66, a subregion of the bearing surface 44 is cut out and bent upwards.

For a fastening of a solar module 12, 16 of a row 20, 22, the mounting rail 36 comprises a fastening region 70. The fastening region 70 is configured for the connection of a fastening module 74. The fastening region 70 is configured for the connection of two solar modules 12, 16, which are arranged side by side, of two rows 20, 22. The mounting rail comprises a second fastening region 72 for a fastening of a solar module 12, 16 of a row 20, 22. The fastening region 72 is configured for the connection of a fastening module 76. The fastening region 72 is configured for the connection of two solar modules 12, 16, which are arranged side by side, of two rows 20, 22 which are arranged side by side. The mounting rail 36 comprises in each case two fastening regions 70, 72 for each solar module 12, 14, 16 of a row 20, 22, respectively for two solar modules 12, 14, 16 which are arranged side by side in the rows 20, 22. In principle, it would also be conceivable that the mounting rail 36 comprises only one fastening region 70 or three fastening regions 70, 72 for a fastening of a solar module 12, 14, 16 of a row, respectively for two solar modules 12, 14, 16 which are arranged side by side in the rows 20, 22.

The solar module fastening device 10 comprises a first fastening module 74 for the connection of the solar module 12, 14, 16 of a row, respectively for two solar modules 12, 14, 16 which are arranged side by side in the rows 20, 22. The fastening module 74 is configured for the connection to one of the fastening regions 70, 72. The solar module fastening device 10 comprises a second fastening module 76 for the connection of the solar module 12, 14, 16 of a row, respectively for two solar modules 12, 14, 16 which are arranged side by side in the rows 20, 22. The solar module fastening device 10 comprises in each case two fastening modules 74, 76 for the connection of the solar module 12, 14, 16 of a row to the mounting rail 36, respectively for the connection of two solar modules 12, 14, 16, arranged side by side in the rows 20, 22, to the mounting rail 36. The fastening modules 74, 76 can be pre-mounted on the mounting rail 36 at the fastening regions 70, 72 in a loss-proof manner. The fastening modules 74, 76 and the fastening regions 70, 72 to which they can be mounted are realized in the same fashion. Therefore, in the following only the one fastening module 74 and the fastening region 70 will be described in detail. The further fastening module 76 and the fastening region 72 for the connection of the two neighboring solar modules 12, 16 as well as all further fastening modules and fastening regions for the connection of the further solar modules are realized in the same fashion. A description thereof may be done on the basis of the following description of the fastening module 74 and the fastening region 70.

For the fastening of a fastening module 74, 76, the mounting rail 36 comprises in each case several mounting holes 78, 80, 82 for each fastening region 70, 72 of the elevated mounting surface 52. The fastening region 70 comprises three mounting holes 78, 80, 82. Two of the mounting holes 78, 80 are realized as pre-mounting and positioning holes. The two mounting holes 78, 80 realized as pre-mounting and positioning holes are configured for a pre-mounting and preferably for a correct positioning of a fastening module 74, 76. The two mounting holes 78, 80 realized as pre-mounting and positioning holes have respectively different diameters. The mounting hole 78 realized as a pre-mounting and positioning hole has a greater diameter than the pre-mounting and positioning hole 80. Due to the different diameters, a correct positioning of a fastening module 74, 76 can be achieved by the two mounting holes 78, 80 which are realized as pre-mounting and positioning holes. The two mounting holes 78, 80 realized as pre-mounting and positioning holes are arranged spaced apart from each other. The two mounting holes 78, 80 realized as pre-mounting and positioning holes are arranged respectively on opposite sides of the third mounting hole 82. The third mounting hole 80 is arranged between the two mounting holes 78, 80 realized as pre-mounting and positioning holes.

The third mounting hole 82 is realized as a fastening hole. The mounting rail 36 has in the mounting surface 52 the mounting hole 82 that is realized as a fastening hole. The mounting hole 82 realized as a fastening hole is arranged between the two mounting holes 78, 80 which are realized as pre-mounting and positioning holes. The mounting hole 82 realized as a fastening hole is configured such that a fastening means, in particular a screw, protrudes through it for the connection of a fastening module.

The mounting hole 82 realized as a fastening hole extends as far as and into the vertical wall 48 that is arranged between the mounting surface 52 and the first bearing surface 44. The mounting hole 82 realized as a fastening hole extends from the mounting surface 52 as far as and into the vertical wall 48. The mounting hole 82 realized as a fastening hole forms, in the mounting surface 52, a long hole that extends from the vertical wall 48 and extends to shortly behind the center of the mounting surface 52. The mounting hole 82 realized as a fastening hole has, in the mounting surface 52, a first diameter that is greater than a shaft diameter of a fastening means, but smaller than a head diameter of the fastening means of a mounting module 74, 76. The subregion that extends into the vertical wall 48 has a second diameter that is greater than a head diameter of the fastening means of a mounting module 74, 76. The subregion of the mounting hole 82 realized as a fastening hole preferably extends substantially over an entire height of the vertical wall 48. A fastening means can be guided with its head through the subregion of the mounting hole which is arranged in the vertical wall 48.

The fastening module 74 is configured to fasten at least one solar module 14, 16 to the mounting rail 36 in a clamping manner. The fastening module 74 is configured to be fastened at the mounting hole 82 that is realized as a fastening hole. The fastening module 74 is configured to be pre-mounted in a self-securing manner at the mounting hole 82 that is realized as a fastening hole. The fastening module 74 is configured to be inserted into the mounting hole 82 sidewise through the subregion of the mounting hole 82 which is arranged in the vertical wall 48.

The fastening module 74 comprises a clamping element 84. The fastening module 86 comprises a spring element 86. The spring element 86 is arranged between the mounting surface 52 and the clamping element 84. The fastening module 74 comprises a screw element 92. The screw element 92 is configured for a coupling with the mounting rail 36. The screw element 92 is configured to be fastened at the mounting hole 82 that is realized as a fastening hole. The fastening module 74 comprises a nut 94. The nut 94 is realized correspondingly to the screw element 92. The nut 94 is configured to be connected to the clamping element 84 in a rotationally fix manner. The fastening module 74 is fixedly connectable to the mounting rail 36 via the screw element 92 and the nut 94.

The clamping element 84 has a U-shaped base body. The clamping element 84 has a base plate. A through hole, through which the screw element 92 can be guided with its threaded shaft, is inserted in the base plate of the clamping element 84. The clamping element 84 has two side walls which adjoin the base plate laterally. The side walls are configured to secure the nut 94 of the fastening module 74 in a rotationally fix manner. The nut 94 is arranged between the side walls of the clamping element 84 in a rotationally fix manner. The clamping element 84 has clamping wings which are arranged at the upper ends of the side walls and extend outwards. The clamping wings form clamping surfaces 96, 98 on their underside. The clamping surfaces 96, 98 are configured, in a mounted state, to contact an edge region of a solar module 12, 16 and to fixedly clamp the respective solar module 12, 16. In principle, it would also be conceivable that a clamping element, in particular a clamping element for a side mounting rail 34, has only one clamping surface.

The spring element 86 is preferably realized as a spring made of a synthetic material. In principle, an implementation of a metal would also be conceivable. The spring element 86 is realized as a compression spring. The spring element 86 has two rigid connection regions which are connected to each other via elastic spring legs 116. The connection regions and the elastic spring legs 116 are realized integrally with one another. The elastic spring legs 116 are elastically deformable relative to each other. A first connection region of the spring element 86 is configured for a coupling with the clamping element 84. The first connection region forms a planar surface as well as connecting pins 112, 114 which project from the planar surface. The connecting pins 112, 114 are configured to be arranged, in a form-fitting manner, in correspondingly realized holes on an underside of the base plate of the clamping element 84. By means of the connecting pins 112, 114, the spring element 86 can be positioned in a rotationally fix manner relative to the clamping element 84. A second connection region of the spring element 86 is configured for a coupling with the mounting surface 52 of the mounting rail 36. The second connection region forms a planar surface as well as positioning pins 88, 90 which project from the planar surface. The positioning pins 88, 90 are configured to be inserted in the mounting holes 78, 80 which are realized as pre-mounting and positioning holes. The positioning pin 88 has a greater diameter and is configured to be arranged in the larger mounting hole 78. The positioning pin 90 has a smaller diameter and is configured to be arranged in the smaller mounting hole 80. This provides an unambiguous orientation of the spring element 86 relative to the mounting rail 36, i.e. an unambiguous orientation of the fastening module 74 relative to the mounting rail 36. The fastening module 74 is only in one way connectable to the mounting rail 36.

For a fastening of the solar modules 12, 16 to the mounting rail 36, the screw element 92 of the fastening module 74, 76 is tightened. By means of the nut 94 that is connected to the clamping element 84 in a rotationally fix manner, as a result of tightening the screw element 92, the nut 94 (and thus the clamping element 84) is pulled towards the mounting rail 36, in particular towards the bearing surfaces 44, 46. Herein the spring element 86 is compressed. The screw element 92 is tightened until the clamping element 84 rests with its clamping surfaces 94, 96 on an upper side of an edge region of the solar modules 12, 16. Further tightening of the screw element 92 will result in the solar modules 12, 16 being clamped—and thus fixedly mounted—with their edge regions in each case between the respective bearing surface 44, 46 and the clamping surfaces 96, 98 of the clamping element 84.

For a tightening of the screw elements 92 of the fastening module 74, the mounting rail 36 comprises respectively one mounting hole 104. The mounting holes 104 are introduced in the bottom wall 60 of the mounting rail 36. The mounting holes 104 are respectively arranged in the region of a fastening region 70, 72. The mounting holes 104 are respectively arranged below a mounting hole 82, realized as a fastening hole, of a fastening region 70, 72. In each case a tool is easily insertable from below through the mounting holes 104 into an inner space of the fastening rail 36 in order to reach and tighten a screw element 92 of a fastening module 74, 76.

Preferably, the fastening regions 70, 72 of the mounting rail 36 additionally comprise fastening tabs 100, 102. The fastening tabs 100, 102 are bent out from the side walls 56, 58 and extend parallel to the bearing surfaces 44, 46. The fastening tab 100 is assigned to the first bearing surface 44 and extends therefrom. The fastening tab 102 is assigned to the second bearing surface 46 and extends therefrom. The fastening tabs 100, 102 extend from the respective bearing surface 44, 46 outwards away from the bearing surface 44, 46, beyond the respective side walls 56, 58. The fastening tabs 100, 102 are configured for an additional or alternative fastening of the solar modules 12, 14, 16, 18. The fastening tabs 100, 102 are configured such that fastening elements, realized as clamping elements, are fastened to the fastening tabs 100, 102 in order to connect the corresponding solar module 12, 14, 16, 18 in a force-fitting and/or form-fitting manner. The fastening tabs 100, 102 are configured for an alternative connection of the solar modules 12, 16, 14, 18. Instead of by means of the fastening modules 74, 76, the solar modules 12, 14, 16, 18 may be fixedly connected to the mounting rail 36 via the fastening tabs 100, 102 by connecting elements which are not shown in detail.

For a mounting of the solar modules 12, 14, 16, 18 on the mounting rails 34, 36, 38, first the fastening modules 74, 76 are pre-mounted at the fastening regions 70, 72 of the mounting rails 34, 36, 38. Herein the fastening modules 74, 76 are inserted with their screw elements 92 sidewise into the mounting holes 82 realized as fastening holes. The positioning pins 88, 90 of the spring elements 86 are inserted into the corresponding mounting holes 78, 80 which are realized as pre-mounting and positioning holes. The screw element 92 and the nut 94 are held in tension by the spring element 86. The screw element 92 is pressed against the underside of the mounting surface 52 by the spring element 86 and is thus secured in a force-fitting manner. The fastening modules 74, 76 are pre-mounted in a loss-proof manner. The solar modules 12, 14, 16, 18 are placed at a lower end onto the corresponding bearing surfaces 44, 46 of the neighboring mounting rails 34, 36, 38. The solar modules 12, 14, 16, 18 are positioned by the bearing surfaces 44, 46 and the vertical walls 48, 50. The solar modules 12, 14, 16, 18 are then correspondingly slid upwards on the bearing surfaces 44, 46, along the mounting direction 204, on the mounting rails 34, 36, 38. Herein the solar modules 12, 14, 16, 18 are pushed over the mounting-securing elements 66, 68 which are integrated in the bearing surfaces. When a solar module 12, 14, 16, 18 has been traversed over the corresponding mounting-securing elements 66, 68, the solar module 12, 14, 16, 18 is secured in the corresponding mounting position by means of the mounting-securing element 66, 68. When the first solar module 12 has been secured in its mounting position, the second solar module 14 of the row 20 can then be slid on (see FIG. 10). In principle, it would also be conceivable to have the front solar modules 12 pushed in each case by the following solar module 14. When the solar modules 12, 14, 16, 18 have been secured by the mounting-securing elements 66, 68 and have been pre-mounted in their mounting positions, the fastening modules 74, 76 can be tightened.

For a clamping-plus-fastening of the solar modules 12, 14, 16, 18, the respective fastening modules are tightened. Herein the screw elements 92 of the fastening modules 74, 76 are tightened. Due to the connection with the nut 94 that is connected to the clamping element 84, the clamping element 84 is pulled towards the mounting rail 36 counter to the spring force of the spring element 86. In a mounted state, the clamping element 84 rests with its clamping surfaces 96, 98 of on the edge regions of the solar modules 12, 14, 16, 18 and clamps them between the clamping element 84 and the respective bearing surface 44, 46. The screw elements 82 of the fastening modules 74, 76 can be easily reached from below through the mounting holes 104.

1. A solar module fastening device with a mounting rail for a fastening of several solar modules, the mounting rail having at least one at least substantially continuous bearing surface which the solar modules can be slid onto for fastening, wherein the mounting rail comprises at least one mounting-securing element, which is configured to permit sliding of solar modules onto the bearing surface in a mounting direction and to secure the solar modules in mounting positions against a displacement counter to the mounting direction.

2. The solar module fastening device according to claim 1, wherein the at least one mounting-securing element is arranged on the bearing surface and rises from the bearing surface.

3. The solar module fastening device according to claim 1, wherein the at least one mounting-securing element is realized as a tab bent out from the bearing surface.

4. The solar module fastening device according to claim 1, wherein the mounting rail has a vertical wall which, at least in a subregion, forms a lateral support surface for the solar modules.

5. The solar module fastening device according to claim 1, wherein the vertical wall of the mounting rail is realized so as to be inclined and forms the lateral support surface only in an upper region that faces away from the bearing surface.

6. The solar module fastening device according to claim 1, wherein the mounting rail has a second at least substantially continuous bearing surface onto which further solar modules can be slid for fastening.

7. The solar module fastening device according to claim 1, wherein the mounting rail has a mounting surface which is elevated relative to the bearing surfaces, which extends between the bearing surfaces and which is configured for the connection of fastening modules for a fastening the solar modules.

8. The solar module fastening device according to claim 1, wherein, for the fastening of a fastening module, the mounting rail has several mounting holes in a mounting surface that is elevated relative to the bearing surfaces.

9. The solar module fastening device according to claim 8, wherein two mounting holes are realized as pre-mounting and positioning holes, having respectively different diameters.

10. The solar module fastening device according to claim 8, wherein the mounting rail has, in the mounting surface, a mounting hole which is realized as a fastening hole, which is preferably arranged between the two mounting holes realized as pre-mounting and positioning holes and which is configured such that a fastening means, in particular a screw element, protrudes through it for the connection of a fastening module.

11. The solar module fastening device according to claim 8, wherein the mounting rail has, in the mounting surface, a mounting hole which is realized as a fastening hole and which extends as far as and into the vertical wall that is arranged between the mounting surface and the first bearing surface.

12. The solar module fastening device according to claim 8, further comprising a fastening module which is configured to fasten at least one solar module to the mounting rail in a clamping manner, the fastening module being configured to be fastened at a mounting hole that is realized as a fastening hole.

13. The solar module fastening device according to claim 12, wherein the fastening module is configured to be pre-mounted at the mounting holes in a self-securing manner.

14. The solar module fastening device according to claim 12, wherein the fastening module comprises a clamping element and a spring element, the spring element being arranged between the mounting surface and the clamping element.

15. The solar module fastening device according to claim 12, wherein the fastening module can be pre-mounted in a positionally secure manner via mounting holes which are realized as pre-mounting and positioning holes, wherein the spring element preferably comprises positioning pins which are inserted into the mounting holes realized as pre-mounting and positioning holes, for a pre-mounting.
